(19) United States
(12) Patent Application Publication
(10) Pub. No.: US 2025/0019161 A1
(43) Pub. Date: Jan. 16, 2025

(54) MODULAR AND ADJUSTABLE UPRIGHT REPAIR DEVICE FOR INDUSTRIAL STORAGE RACKS

(71) Applicant: Spaceguard Products Inc., Seymour, IN (US)

(72) Inventors: Kevin Eugene Ackeret, Seymour, IN (US); Monty Wayne Reynolds, Land O Lakes, FL (US); Edward Michael Murphy, Columbus, IN (US); Chase Thomas Murphy, Columbus, IN (US)

(21) Appl. No.: 18/770,588

(22) Filed: Jul. 11, 2024

Related U.S. Application Data
(60) Provisional application No. 63/526,181, filed on Jul. 11, 2023.

(51) Int. Cl. B65G 1/02

(52) U.S. Cl. CPC B65G 1/02

(57) ABSTRACT

The modular and adjustable system repairs structural damage or proactively prevents future damage to the upright frames of industrial pallet racks. The system includes several components to repair damage to pallet racks having a variety of shelf and upright connection types at various heights and depths. An angular adjustable strut may be fitted between a replacement column and the floor to provide additional stability without overloading a repaired component of the pallet rack. Additionally, a cuff provides further adjustability for small differences between manufacturers or field installation conditions such as shimming at the floor. In combination, the system transfers various forces on the pallet rack below the original repair back to the floor.

### CROSS-REFERENCE TO RELATED APPLICATIONS

This non-provisional patent application claims priority to U.S. Provisional Patent Application Ser. No. 63/526,181 filed on Jul. 11, 2023 and entitled “MODULAR AND ADJUSTABLE UPRIGHT REPAIR DEVICE FOR INDUSTRIAL STORAGE RACKS.” The disclosure of U.S. Ser. No. 63/526,181 is entirely incorporated by reference, herein.

### TECHNICAL FIELD

The present disclosure relates generally to the field of industrial storage racks and, more particularly, to a modular and adjustable upright repair device for industrial storage racks.

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

Industrial storage racks are essential components of warehouses, factories, and other industrial settings where efficient storage and organization of goods and materials are necessary. These racks provide a structured and systematic approach to storing various items, maximizing space utilization, and facilitating easy access and retrieval. Industrial storage racks are designed to withstand heavy loads. They are constructed using robust materials like steel or aluminum, ensuring durability and the ability to support substantial weight. These racks can accommodate a wide range of items, including pallets, boxes, containers, barrels, equipment, and other inventory. They come in different sizes, configurations, and shelving options to meet specific storage needs. Industrial storage racks are designed to optimize vertical space. By utilizing the height of the facility, they allow for efficient storage of goods, freeing up valuable floor space. This is particularly important in warehouses and factories with limited square footage. The design of industrial storage racks ensures easy access to stored items. They provide clear aisles for personnel and material handling equipment, such as forklifts or pallet jacks, to navigate and retrieve items quickly. Industrial storage racks are engineered to meet safety standards and regulations. They have features like reinforced frames, load capacity labels, and safety accessories to prevent accidents, such as falling items or rack collapse.

One type of industrial storage rack is a pallet rack. These racks are designed to store palletized goods. They feature connected uprights and horizontal beams that create multiple levels of storage, allowing forklifts or pallet jacks to load and unload pallets easily. Uprights include vertical columns and horizontal and/or angular struts that provide the main support for the pallet rack system. They are typically made of heavy-duty steel and come in various heights and widths to accommodate different storage needs. Uprights generally have rows of evenly spaced holes or slots to allow for the attachment of horizontal beams. Beams are horizontal components that connect the uprights and form the levels of the pallet rack system. They create the platforms on which pallets are placed. Beams are available in different lengths and load capacities to accommodate varying pallet sizes and weights. They are typically adjustable, allowing for flexibility in shelf heights. Pallets racks may be accessorized with wire decking consisting of mesh panels that fit onto the beams to provide a solid surface for storing non-palletized items or for additional support for pallets. Wire decking enhances safety by preventing smaller items from falling between the beams. Pallet supports are optional components used to provide additional support to pallets. They are installed between beams and help distribute the weight of the pallet evenly. Pallet supports are particularly useful for storing heavy or non-standard pallets. Load beams, also known as step beams or box beams, are specialized beams with a step or box-like profile. They have an additional ledge or lip along the top edge, which helps secure pallets in place and prevents them from sliding off.

Proper maintenance and timely repair of industrial storage racks are essential to ensure their longevity, safety, and continued functionality. If any components of the rack system are damaged or compromised, such as bent beams or uprights (including bent columns and struts), these components should be replaced or repaired promptly while still meeting safety standards. Typical beam and upright repair solutions require a substantial amount of modification in the field. Also, because rack repair connections vary by original equipment manufacturer, many kits require long manufacturing lead times to produce. Current pallet rack repair solutions cannot be adjusted for different rack manufacturers and require time-consuming field modification of the standing rack for repair hardware fitting. Even when fitted properly, past repair solutions transferred load and impact forces to the rear upright column or other component of the racking system instead of the floor itself, leading to repeated failures. Other solutions either do not allow for load beams to be safely re-engaged below the repair height without modification or extended manufactured lead times. Thus, there is a need for an industrial storage rack repair system that is adaptable to a variety of rack designs and variances caused by shims, base plate thicknesses, and other factors while also limiting future or repeated damage in the repaired area.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

The modular and adjustable system repairs structural damage or proactively prevents future damage to the upright frames of industrial pallet racks. The system includes several components to repair damage to pallet racks having a variety of shelf and upright connection types at various heights and depths. An angular adjustment beam may be fitted between an column and the floor to provide additional stability without overloading a repaired component of the pallet rack. Additionally, a cuff provides further adjustability for small differences between manufacturers or field installation conditions such as shimming at the floor. In combination, the system transfers various forces on the pallet rack below the original repair back to the floor.

In some embodiments, a multi-piece replacement column base assembly including a separate replacement column and replacement column base may repair or replace a damaged upright column of a pallet rack. A coupler may align and join the upright column to the base. The coupler may be sized to fit within or around the replacement column or the replacement base. The replacement column may be cut to the length of a damaged portion of a pallet rack upright and fitted to the replacement column base.

In further embodiments, a one-piece replacement column base assembly may be one, continuous piece including a column and a column base to repair or replace a damaged upright column of a pallet rack. The one-piece replacement column and base may be cut to the length of a damaged portion of a pallet rack upright and fitted to the upright column base.

An angular adjustable strut may be affixed to the replacement column or to the replacement base in both the multi-piece and one piece embodiments. The angular adjustable strut may extend at a downward angle from the replacement column, through a connection saddle that covers a gap in a horizontal adjustable strut, and affixed to the floor. The horizontal adjustable strut may be affixed horizontally between the replacement column and an existing pallet rack upright column. The angular adjustable strut may provide both vertical and horizontal stability to the pallet rack and direct force away from a repaired portion of the pallet rack.

### BRIEF DESCRIPTION OF THE DRAWINGS

Non-limiting and non-exhaustive embodiments are described in reference to the following drawings. The components in the figures are not necessarily to scale, emphasis instead being placed upon illustrating the principles of the disclosure. In the drawings, like reference numerals refer to like parts through all the various figures unless otherwise specified.

For a better understanding of the present disclosure, a reference will be made to the following detailed description, which is to be read in association with the accompanying drawings, wherein:

FIG. 1 is a perspective view of an industrial rack repair system using a multi-piece replacement column base assembly as installed on an industrial rack, thereby forming an upright, in accordance with one embodiment of the disclosure;

FIG. 2 is a side view of the industrial rack repair system of FIG. 1 using a multi-piece replacement column base assembly as installed on an industrial rack, thereby forming an upright;

FIG. 3 shows various components of the industrial rack repair system of FIG. 1;

FIG. 4 is a perspective view of the multi-piece replacement column base assembly of the industrial rack repair system of FIG. 1;

FIG. 5A is an outer view of the multi-piece replacement column base assembly of the industrial rack repair system of FIG. 1;

FIG. 5B is an inner view of the multi-piece replacement column base assembly of the industrial rack repair system of FIG. 1;

FIG. 6A is a first side view of the multi-piece replacement column base assembly of the industrial rack repair system of FIG. 1;

FIG. 6B is a second side view of the multi-piece replacement column base assembly of the industrial rack repair system of FIG. 1;

FIG. 7 is a perspective view of an industrial rack repair system using a one-piece replacement column base assembly as installed on an industrial rack, thereby forming an upright, in accordance with one embodiment of the disclosure;

FIG. 8 is a side view of the industrial rack repair system of FIG. 7 using a one-piece replacement column base assembly and base as installed on an industrial rack, thereby forming an upright;

FIG. 9 is a perspective view of an industrial rack repair system using a multi-piece replacement column base assembly as installed on an industrial rack, thereby forming an upright, in accordance with another embodiment of the disclosure;

FIG. 10 is a perspective view of an industrial rack repair system using a one-piece replacement column base assembly as installed on an industrial rack, thereby forming an upright, in accordance with another embodiment of the disc;

FIG. 11 is a perspective view of an industrial rack repair system comprising two replacement columns, in accordance with one embodiment of the disclosure; and

FIG. 12 is a perspective view of an industrial rack repair system comprising two replacement columns as installed on an industrial rack, thereby forming an upright, in accordance with one embodiment of the disclosure.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DETAILED DESCRIPTION

The present disclosure now will be described more fully hereinafter with reference to the accompanying drawings, which form a part hereof, and which show, by way of illustration, specific exemplary embodiments by which the disclosure may be practiced. This disclosure may, however, be embodied in many different forms and should not be construed as limited to the embodiments set forth herein; rather, these embodiments are provided so that this disclosure will be thorough and complete, and will fully convey the scope of the claims to those skilled in the art. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, although it may. Furthermore, the phrase “in another embodiment” as used herein does not necessarily refer to a different embodiment, although it may. Thus, as described below, various embodiments of the disclosure may be readily combined, without departing from the scope or spirit of the disclosure.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and includes plural references. The meaning of “in” includes “in” and “on.”

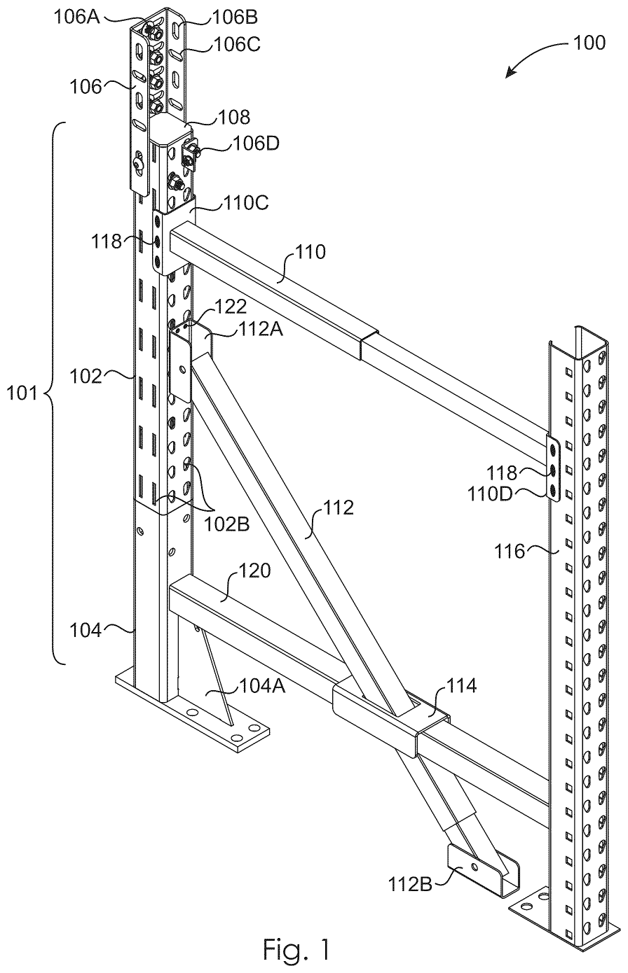

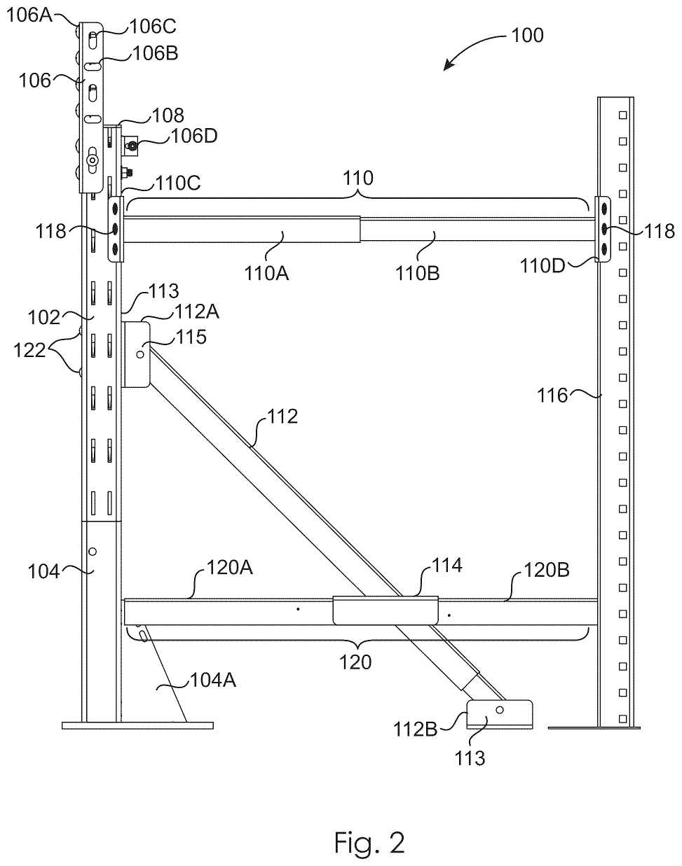

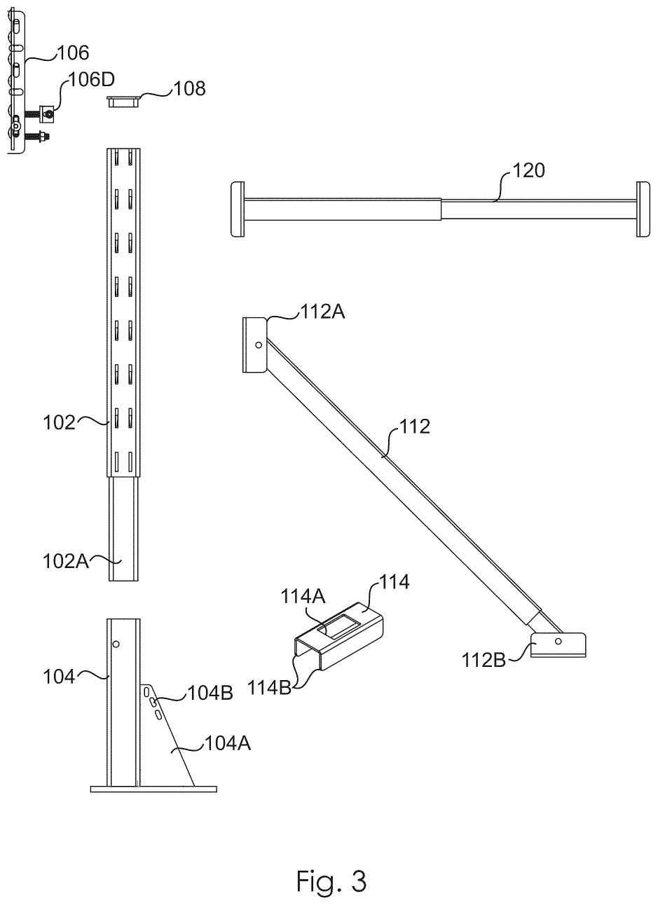

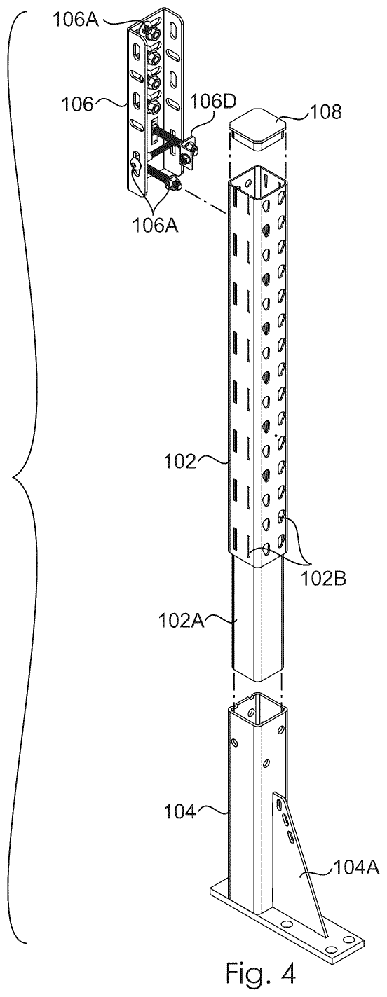

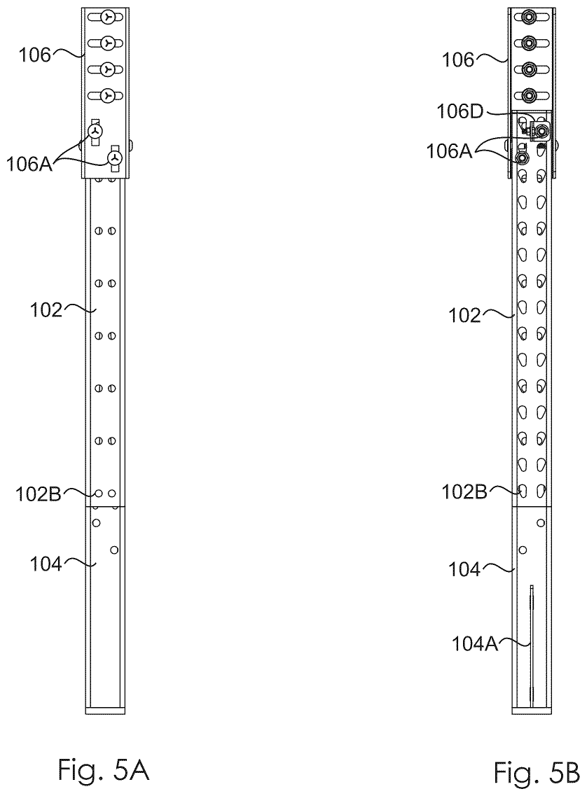

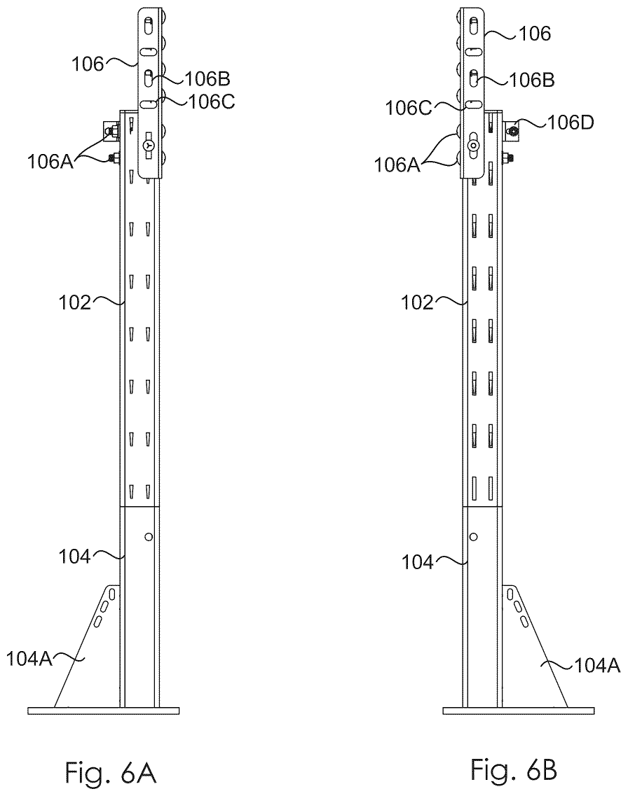

The disclosure describes embodiments of a system for repairing damaged uprights (e.g., columns and/or struts) of an industrial storage rack. FIG. 1 shows a perspective view of an industrial rack repair system 100 in accordance with one embodiment of the present disclosures and FIG. 2 shows a side view of the industrial rack repair system 100. With reference to FIGS. 1-6B, some embodiments of the system 100 may include multi-piece (e.g., two-piece) replacement column base assembly 101, which in turn may include a replacement column 102 and a replacement column base 104. Additional elements of the system 100 may include a column cuff 106, an column cap 108, a horizontal adjustable strut 110, an angular adjustable strut 112, and a connection saddle 114. In one embodiment, the remaining elements depicted in FIG. 1 that are not associated with the foregoing, e.g., existing column 116 and horizontal strut 120, may be affiliated with a pallet rack separate from system 100. In another embodiment horizontal strut 120 may be included in system 100. Replacement column 102 may replace a damaged portion of an existing column (not depicted, but similar to 116). For example, a pallet rack may include multiple (e.g., 4) columns, each substantially similar to column 116. One such column may be damaged and it may be desirable to remove the damaged portion. Upon removal of the damaged portion of a column, system 100 may be used to brace and support the undamaged portion (not depicted). The replacement column 102 may be shaped to receive one or more couplers 102A (FIG. 3) at one or more ends of the replacement column 102. The coupler(s) 102A may join the replacement column 102 to the replacement column base 104 and/or portions of a pallet rack column with a damaged portion removed. In some embodiments, the one or both ends of the replacement column 102 may be shaped to slide over a coupler 102A like a sleeve and the replacement column 102 and coupler 102A may be welded together. Portions of the coupler 102A protruding from the end of the replacement column 102 may then engage the replacement column base 104 and/or portions of a pallet rack existing column with a damaged portion removed. The replacement column 102 may include a square tube section that is perforated on all four sides with common pallet rack cutout profiles 102B and connection patterns including teardrop, Interlake new-style teardrop, Unarco T-bolt, Ridg-U-Rak slotted, structural, keystone, Sturdibilt, and side mount load beam/strut connection patterns. In one embodiment, each side of the replacement column 102 is perforated with a specific common pallet rack cutout profile. In other embodiments, each side of the replacement column 102 is perforated with one more specific common pallet rack cutout profiles (e.g., two profiles). The side of the replacement column 102 that conforms with or to desired pallet rack cutout profiles associated with another portion of the pallet rack (e.g., pallet rack column 116) may be positioned to face such other portion so that horizontal or angular struts, beams, members, supports or other members of system 100 may be coupled to the replacement column 102 and to another portion of the pallet rack (e.g., existing column 116). For example, if pallet rack existing column 116 has teardrop profiles, the side of the replacement column 102 with teardrop profiles may be positioned to face the existing column 116 to which it will be coupled via struts, beams, members, supports or other aspects of system 100, e.g., horizontal adjustable strut 110 and horizontal strut 120. The caudal end of a replacement column may include a flange configured to be disposed against the replacement base 104, and fasteners may couple the caudal end of the replacement column to the replacement base 104 via the flange. The replacement base 104 may also include a reinforcing member 104A to provide additional support for the multi-piece replacement column base assembly 101. In some embodiments, the reinforcing member 104A includes a triangular gusset that is formed with or welded to the replacement base 104. The reinforcing member 104A may also include one or more mounting holes 104B that are shaped to receive an existing or additional horizontal or angular support structure (e.g., struts or beams) between the multi-piece column base assembly 101 and the existing column 116. For example, one or more fasteners (not shown) may pass through both a horizontal strut 120 and one or more mounting holes 104B to affix the horizontal strut 120 to the reinforcing member 104A.

The column cuff 106 may couple replacement column 102 to an undamaged portion of a damaged column (not depicted). The damaged portion may be cut away and an undamaged portion of the existing column may remain. The caudal portion of the undamaged portion of the existing column may be coupled to the replacement column 102 using cuff 106. In one embodiment, the caudal end of the undamaged portion of the existing column may rest or sit on and thereby be at least partially supported by column cap 108. In other words, a cephalic portion of the replacement column is configured to support a caudal portion of the damaged column. In other embodiments, there may exist a space between the caudal end of the undamaged portion of the damaged column and the column cap 108. The column cuff 106 may be coupled to both the replacement column 102 and the undamaged portion of a damaged existing column (e.g., a caudal portion). The column cuff 106 may provide further adjustability for small height differences between manufacturers or field installation conditions such as shimming at the floor and base plate thicknesses. In some embodiments, the cuff 106 is a connection joint. The cuff 106 may be formed of steel or other material that is suitable to withstand various load forces of the pallet rack in operation. For example, the cuff 106 may be made from sheet steel and formed into a “C” shape to cradle both the replacement column 102 and the existing cut away rack section or undamaged portion of a damaged existing column. The cuff 106 may have several horizontal 106B and vertical 106C slots to accommodate a variety of pallet rack hole patterns. The cuff 106 may include one or more fasteners 106A (e.g., bolts, nuts, washers, grade 8 hardware, etc.) to help secure the cuff 106 to the replacement column 102 and/or an undamaged portion (e.g., a caudal portion) of damaged existing column. In some embodiments, fasteners 106A may include at least one unique fastener to make connections that would protrude into a pallet storage area resulting in a “no snag” connection (e.g., a barrel nut). The column cuff 106 may also include fasteners and/or hardware to affix additional or existing support structures (e.g., struts and beams) on the multi-piece upright 101 or between the multi-piece column base assembly 101 and the pallet rack existing column 116. For example, a horizontal or angular strut between pallet rack existing columns may have been affixed to a damaged portion of an existing column. During the repair process, this horizontal or angular strut may be separated from the damaged portion of the existing column and then re-attached to the replacement column 102. In some embodiments, a right angle bracket 106D may be used to reattach this existing horizontal or diagonal strut on the multi-piece upright 101 or between the multi-piece column base assembly 101 and the pallet rack existing column 116.

The horizontal adjustable strut 110 may be fitted between the replacement column 102 and the pallet rack existing column 116 to provide lateral (e.g., forward and backward) stability for the pallet rack. The horizontal adjustable strut 110 may include a first horizontal adjustable strut portion 110A and a second horizontal adjustable strut portion 110B. One or both of the portions (i.e., 110A or 110B) may move relative to the other portion (i.e., 110A or 110B) to change the overall length of the horizontal adjustable strut 110, e.g., to set the depth or width of the repair to match the existing pallet rack depth or width. In some embodiments, the portions 110A, 110B may be joined in a sliding manner. For example, the first horizontal adjustable strut portion 110A may slide within the second horizontal adjustable strut portion 110B to change the overall length of the horizontal adjustable strut 110. Once the horizontal adjustable strut 110 is adjusted to set the depth or width of the repair to match the existing pallet rack depth or width, the first horizontal adjustable strut portion 110A and the second horizontal adjustable strut portion 110B may be fixed together (e.g., using welding, brackets, fasteners, etc.). In other embodiments, the first horizontal adjustable strut portion 110A and the second horizontal adjustable strut portion 110B may be urged away from each other to provide a tension fitting or may include a shock absorbing member to minimize any relative motion between the replacement column 102 and the pallet rack existing column 116. The strut 110 may include one or more end fasteners to affix the horizontal adjustable strut 110 to the one or more a pallet rack existing columns 116 or replacement column 102. For example, the end fasteners may be shaped to receive the pallet rack existing column 116 and/or replacement column 102 (e.g., via a saddle bracket 110C, 110D that is shaped to receive the pallet rack existing column 116 and/or replacement column 102 between two “wings”). In another embodiment, the pallet rack existing column 116 and/or replacement column 102 may be shaped to receive the end fasteners (e.g., saddle bracket 110C, 110D, or other components). Hardware may be used to secure the end fasteners to the replacement column 102 and the pallet rack existing column 116. For example, hardware (e.g., bolts, nuts, etc.) 118 may pass through the “wings” of the saddle bracket 110C and the replacement column 102 as well as the saddle bracket 110D and pallet rack upright 116 to affix the horizontal adjustable strut 110 between the replacement column 102 and the pallet rack existing column 116.

The angular adjustable strut 112 may be fitted between the replacement column 102, the horizontal strut 120, and the floor to provide both vertical and horizontal stability to a repaired portion of the pallet rack. A portion (e.g., a damaged portion) of the horizontal strut 120 may be removed to create a gap between a horizontal strut first portion 120A and a horizontal strut second portion 120B. The angular adjustable strut 112 may pass through an angular adjustable strut opening 114A in the connection saddle 114 and the gap between the horizontal strut first portion 120A and the horizontal strut second portion 120B. In some embodiments, the angular adjustable strut 112 may include one or more sliding portions similar to the horizontal adjustable strut 110 to change the overall length of the angular adjustable strut 112. For example, a first portion of the angular adjustable strut 112 may receive a second portion of the angular adjustable strut. The second portion of the strut 112 may slide within the first portion of the strut 112 to vary the length of the strut 112 and optimize stability of the repaired pallet rack.

In some embodiments, the connection saddle 114 may be welded or otherwise affixed to the horizontal strut first portion 120A and the horizontal strut second portion 120B. The connection saddle 114 replaces the removed portion of the horizontal strut 120 to bridge the gap between the horizontal strut first portion 120A and the horizontal strut second portion 120B. The angular adjustable strut 112 may be anchored to both the replacement column 102 and the floor to direct energy from future impacts to the floor rather than the repaired portion of the rack (e.g., multi-piece column base assembly 101 or replacement column 102), an existing column (i.e., column 116), or other area of the pallet rack. The connection saddle 114 may include an angular adjustable strut opening 114A (FIG. 3). The angular adjustable strut opening 114A may be configured to receive the angular adjustable strut 114. In some embodiments, the angular adjustable strut opening 114A may be sized for the angular adjustable strut 114 to fit within the gap between the horizontal strut first portion 120A and the horizontal strut second portion 120B at an angle relative to the replacement column 102. In use, the relative positions of the angular adjustable strut 112, replacement column 102, and floor may form a triangle to direct static and dynamic forces away from repaired portions of the pallet rack (e.g., the replacement column 102 and horizontal strut 120) to the floor. In some embodiments, the connection saddle 114 includes one or more lateral bracing members 114B. When positioned over a gap/repair on the horizontal strut 120 (i.e., between the horizontal strut first portion 120A and the horizontal strut second portion 120B), distal portions of the connection saddle 114 may rest on corresponding portions of the horizontal strut first portion 120A and the horizontal strut second portion 120B. The lateral bracing members 114B may extend caudally toward the floor on each side of the horizontal strut first portion 120A and the horizontal strut second portion 120B to laterally brace the repaired horizontal strut 120. The connection saddle 114 may be affixed to the horizontal strut 120 to join the horizontal strut first portion 120A and the horizontal strut second portion 120B. For example, portions of the lateral bracing members 114B that cover or overlap the horizontal strut first portion 120A and the horizontal strut second portion 120B may be welded in place.

The angular adjustable strut 112 may also include one or more end fasteners or footings to join the strut 112 to one or more of the replacement column 102, pallet rack existing column 116, and/or the floor. In some embodiments, the angular adjustable strut 112 may include footings 112A, 112B to secure the strut 112 in place as shown in FIGS. 1 and 2. The footings 112A, 112B may include hardware (e.g., bolts, nuts, etc.) 122 that passes through the footing 112A and the upright column 102 as well as the footing 112B and into the floor or other base to affix the angular adjustable strut 112 between the replacement column 102 and the floor. The footings 112A, 112B may be affixed to both the replacement column 102 and the floor. For example, a first footing 112A may be bolted or welded to the replacement column 102 and a second footing 112B may be bolted or otherwise affixed to the floor. In other embodiments, one or more of the footings 112A, 112B may include a friction-increasing pad 113 (FIG. 2) or other structure to hold the footings 112A, 112B in place. The footings 112A, 112B may also include a pivot pin 115 (FIG. 2). The pivot pin 115 may allow the footing 112A, 112B to rotate around each respective distal end of the angular adjustable strut 112 so that the strut 112 may be placed at a variety of angles depending on with the location of the repair on the horizontal strut 120. Footings 112A, 112B maintain a secure mating position with the upright column 102, floor, or other surface.

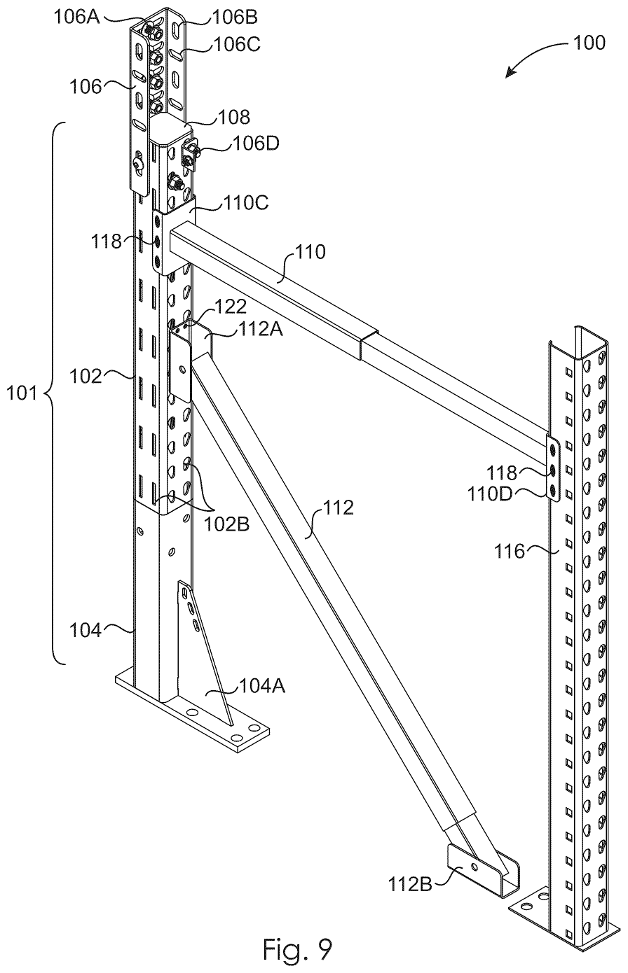

FIG. 9 shows a perspective view of an industrial rack repair system 900 in accordance with one embodiment of the present disclosures. In one embodiment, the industrial rack repair system 900 may include elements of the industrial rack repair system 100 of FIG. 1, but without the horizontal strut 120 and connection saddle 114.

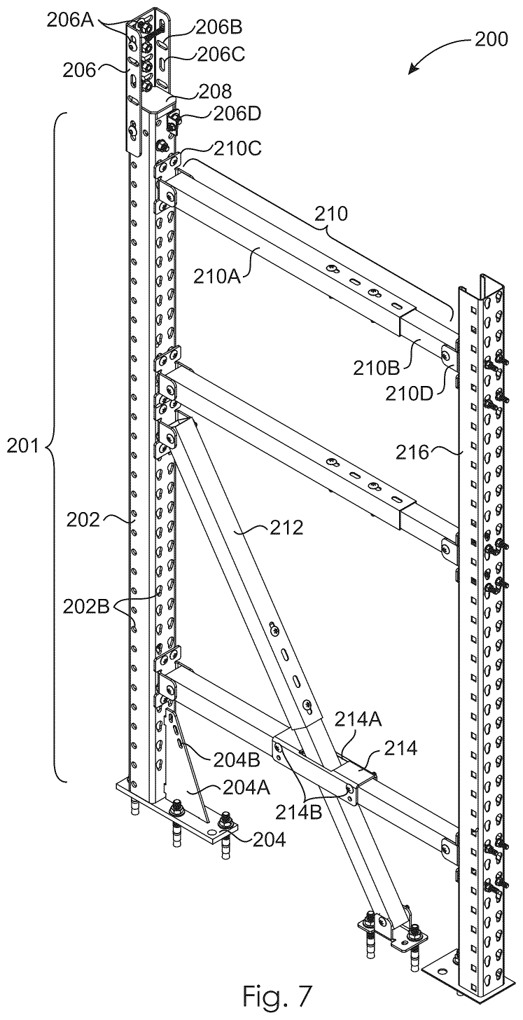

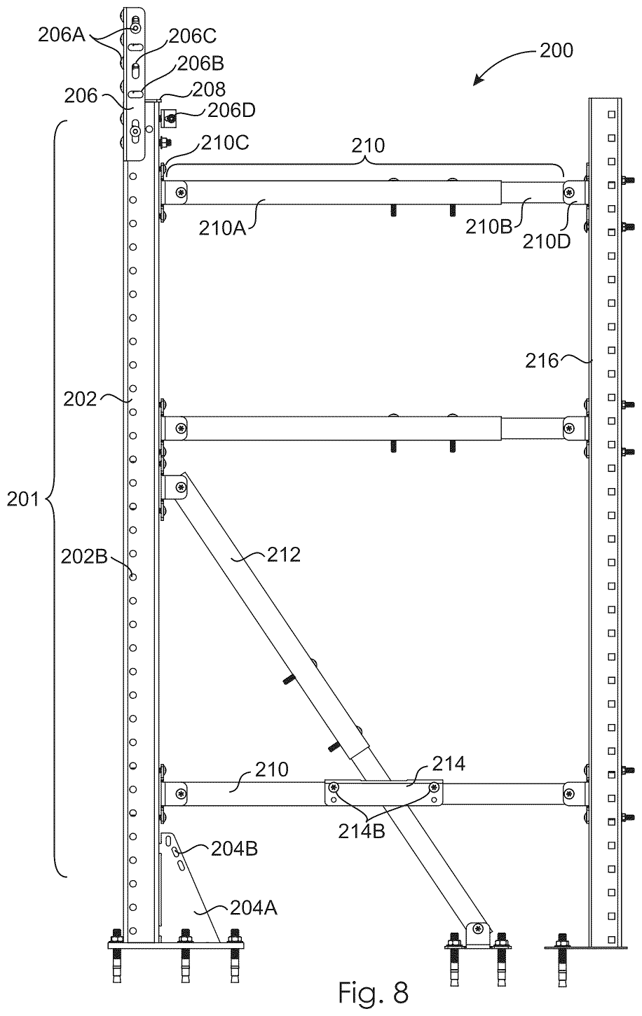

With reference to FIGS. 7 and 8, another embodiment of an industrial rack repair system is disclosed. FIGS. 7 and 8 may include system 200, which may be configured to include one-piece column base assembly 201 including an replacement column 202 and replacement base 204 as a single piece. For example, replacement column 202 and replacement base 204 may be welded together such that it can be considered integrated as a single piece. Like the system 100 of FIGS. 1-6B, the system 200 may include an column cuff 206, an column cap 208, a horizontal adjustable strut 210, an angular adjustable strut 212, and a connection saddle 214. Upright 216 may be affiliated with a pallet rack separate from system 200. The one-piece column base assembly 201 may replace a damaged portion of a pallet rack column (not depicted). The one-piece column base assembly 201/replacement column 202 may include a square tube section that is perforated on one or more sides (e.g., all four sides) with common pallet rack cutout profiles 202B and connection patterns including teardrop, Interlake new-style teardrop, Unarco T-bolt, Ridg-U-Rak slotted, structural, keystone, Sturdibilt, and side mount load strut connection patterns. In one embodiment, each side of the one-piece column base assembly 201/replacement column 202 is perforated with a specific common pallet rack cutout profile. In other embodiments, each side of the one-piece column base assembly 201/replacement column 202 is perforated with one more specific common pallet rack cutout profiles (e.g., two profiles).

The one-piece column base assembly 201 may also include a reinforcing member 204A at the base 204 to provide additional support for the one-piece column base assembly 201. In some embodiments, the reinforcing member 204A includes a triangular gusset that is formed with or welded to the one-piece column base assembly 201/replacement 202. The reinforcing member 204A may also include one or more mounting holes 204B that are shaped to receive an existing or additional horizontal or angular strut between the one-piece column base assembly 201 and the pallet rack existing column 216 (not depicted). For example, one or more fasteners (not shown) may pass through both a horizontal or angular strut (not shown) and one or more mounting holes 204B to affix the horizontal or angular strut to the reinforcing member 204A.

The column cuff 206 may couple one-piece column base assembly 201 to an undamaged portion of a damaged column (not depicted). The damaged portion may be cut away and an undamaged portion of the existing column may remain. The caudal portion of the undamaged portion of the existing column may be coupled to the one-piece column base assembly 201 using cuff 206. In one embodiment, the caudal end of the undamaged portion of the existing column may rest or sit on and thereby be at least partially supported by column cap 208. In other embodiments, there may exist a space between the caudal end of the undamaged portion of the damaged column and the replacement column cap 208.

The column cuff 206 may be coupled to both the replacement column 202 and the undamaged portion of a damaged column (e.g., a caudal portion). The column cuff 206 may also provide further adjustability for small height differences in the upright portion of the pallet rack. The cuff 206 may be formed of steel or other material that is suitable to withstand various load forces of the pallet rack in use. The cuff 206 may be made from sheet steel and formed into a “C” shape to cradle both the replacement column 202 and the existing cut away rack section (e.g., undamaged portion of a damaged column). The cuff 206 may have several horizontal 206B and vertical 206C slots to accommodate a variety of pallet rack hole patterns. The cuff 206 may also include one or more fasteners 206A (e.g., bolts, nuts, washers, grade 8 hardware, etc.) to help secure the cuff 206 to the one-piece column base assembly 201/replacement column 202. In some embodiments, fasteners 206A may include at least one unique fastener to make connections that would protrude into a pallet storage area resulting in a “no snag” connection (e.g., a barrel nut). The column cuff 206 may also include fasteners and/or hardware to affix additional or existing support structures (e.g., struts and beams) on the one-piece column base assembly 201 or between the one-piece column base assembly 201 and the pallet rack existing column 216. For example, a horizontal or angular support structure (e.g., strut or beam) may have been affixed to a damaged portion of an column. During the repair process, this horizontal or angular support strut or beam structure may be separated from the damaged column portion and then re-attached to the new one-piece column base assembly 201/replacement column 202. In some embodiments, a right angle bracket 206D may be used to reattach this existing horizontal or diagonal support member (strut or beam) on the one-piece column base assembly 101 or between the one-piece column base assembly 101 and the pallet rack existing column 116.

A horizontal adjustable strut 210 may be fitted between the one-piece column base assembly 201/replacement column 202 and the pallet rack existing column 216 to provide lateral (e.g., forward and backward) stability for the pallet rack. The horizontal adjustable strut 210 may include a first horizontal adjustable strut portion 210A and a second horizontal adjustable strut portion 210B. Before mounting between the one-piece column base assembly 201 and the pallet rack existing column 216, the first horizontal adjustable strut portion 210A may slide in relation to the second horizontal adjustable strut portion 210B to configure the length of the horizontal adjustable strut 210. The overall length of the horizontal adjustable strut 210 may be set to match the existing pallet rack depth or width.

The strut 210 may include one or more end fasteners to affix the horizontal adjustable strut 210 to the one or more a pallet rack upright 216 or upright column and base 202. For example, the end fasteners may include a bracket 210C, 210D that is affixed to both the horizontal adjustable strut 210 and the pallet rack existing 216 or one-piece column base assembly 201.

The angular adjustable strut 212 may be fitted between the one-piece column base assembly 201, an horizontal adjustable strut 210, and the floor to provide both vertical and horizontal stability to a repaired portion of the pallet rack. A horizontal strut 210 with a connection saddle 214 may replace a damaged portion of the pallet rack or may be added to the pallet rack for increased stability. The angular adjustable strut 212 may pass through an angular adjustable strut opening 214A in the connection saddle 214 and a gap in the horizontal adjustable strut 210. In some embodiments, the angular adjustable strut 212 may include one or more sliding portions similar to the horizontal adjustable strut 210 to change the overall length of the angular adjustable strut 212 and optimize stability of the repaired pallet rack.

Fasteners 214B may affix the connection saddle 214 to the horizontal adjustable strut 210. The connection saddle 214 may replace a damaged portion of a horizontal adjustable strut 214 to bridge the gap that is created once the damaged portion is removed. In other embodiments, the horizontal adjustable strut 210 and connection saddle 214 may replace an entire horizontal member of the pallet rack or may be added to reinforce the stability of the rack. The angular adjustable strut 212 anchors to both the one-piece column base assembly 201 and the floor to direct energy from future impacts to the floor rather than the repaired portion of the rack, the existing non-repaired leg (i.e., pallet rack upright 216), or other area of the pallet rack.

The various embodiments may be constructed for various column widths (e.g., 3″, 4″ or 5″+/−0.25″). The horizontal adjustable struts (110, 210) may be adjustable to various depths (e.g., 24″ to 84″ of overall depth in the upright frame) or widths. The struts 110, 201 may also allow smaller amounts of adjustability for the variety of depths or widths of columns that are in the market. The replacement columns 102 and 202 and the multi-piece column base assembly 101 and the one-piece column base assembly 201 may also be available in a variety of heights that damage may occur and the number of horizontal adjustable struts (110, 210) may be added as the height of the repair increases. Connection types may include various connection patterns including: teardrop, Interlake new-style teardrop, Unarco T-bolt®, Ridg-U-Rak® slotted, structural, keystone, Sturdibilt®, and side mount load beam or strut connection types. The disclosure may also vary in color to match original equipment manufacturers paint colors from time to time. Additionally, having multiple versions of the base 104 or the column 202 and base 204 may allow the system 100, 200 to be used for seismic and non-seismic zones without having to manufacture an entire solution for the seismic requirement.

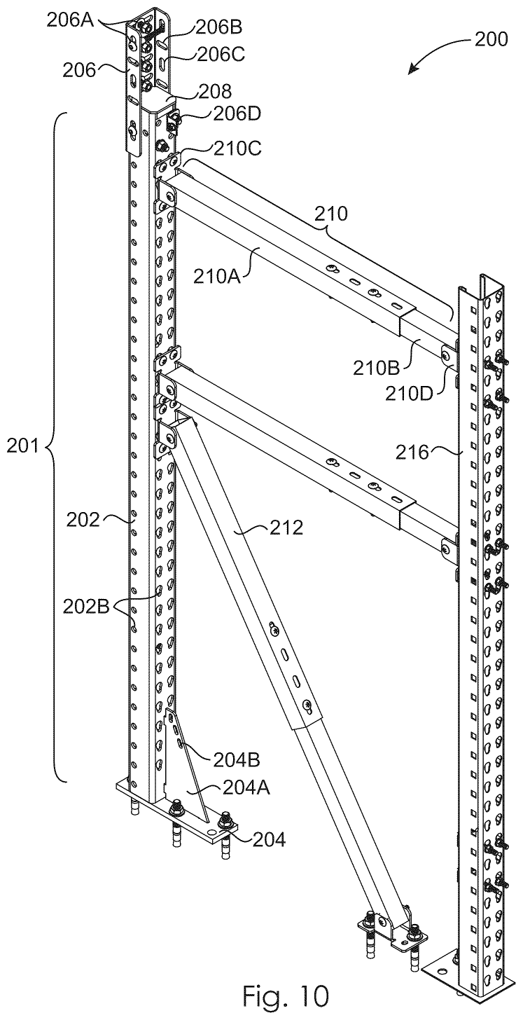

With references to FIGS. 1-10, and without deviating from the scope of the disclosure, one of skill in the art will readily appreciate that (a) the above-described adjustable struts may be replaced with non-adjustable struts; (b) the above-described angular adjustable struts and the horizontal adjustable struts may be implemented as a first strut and a second strut; (c) such a second strut may be horizontal or substantially horizontal such that the second strut is configured to be disposed substantially parallel to the floor (e.g., situated at less than a 45 degree angle with respect to the floor); (d) the replacement column may have one or more faces that are flat or non-flat; and (e) coupler may be receivable by either or both of a replacement column and a replacement base. In other embodiments, a strut may be configured to be disposed between a replacement column and an existing column of an industrial pallet rack and disposed at an angle with respect to the floor. For example, such a strut may have a first end that is configured to be affixed to a face of the replacement column and a second end that terminates at (e.g., is already affixed to or is configured to be affixed to) such an existing column. The first end may be disposed above or below the second end. Further, it is contemplated that brackets and footings may be interchangeable as connection members for various struts.

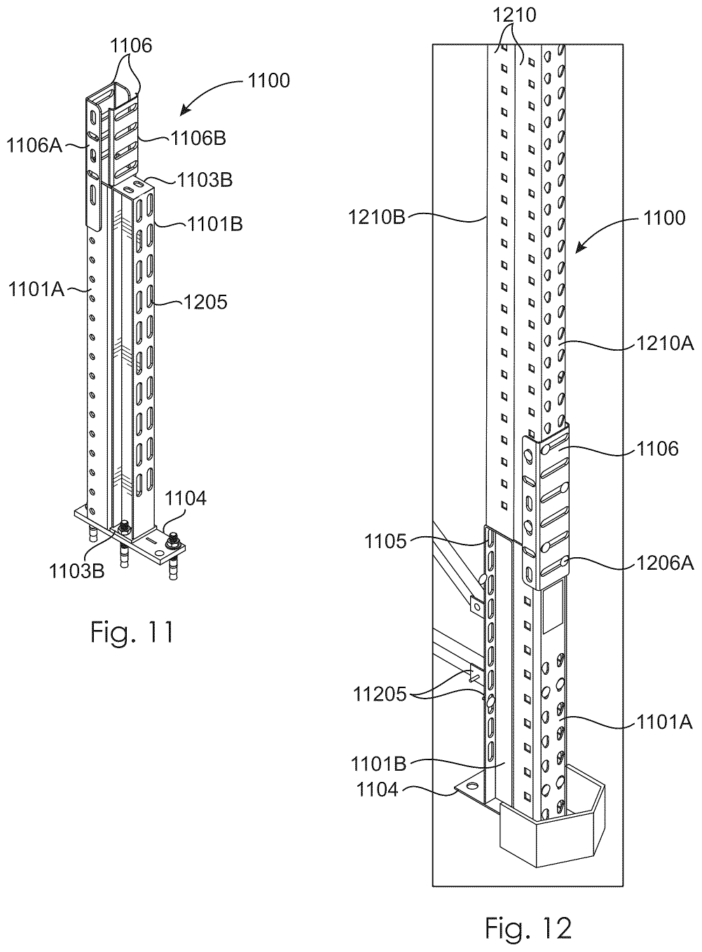

With reference to FIGS. 11 and 12, an industrial rack repair system 1100, 100, 200, 900, 1000, etc., may include an industrial rack repair system 1100, with FIG. 11 showing the system 1100 in isolation, and FIG. 12 showing the system 1100 of FIG. 11 in a double-column repair configuration and turned 180° from the perspective shown in FIG. 11. The system 1100 includes two replacement sub-columns, or a first replacement column 1101A and a second replacement column 1101B, in accordance with embodiments of the disclosure. The second replacement column 1101B may be shaped for structural support in its given configuration (i.e., single-or double-column repair configuration). For example, in a single-column repair configuration, the second replacement column 1101B may operably support the first replacement column when the second replacement column 1101B does not have a second column member 1210B placed on top. In a double-column repair configuration, the first replacement column 1101A may support the caudal end of a first column member 1210A of a double column 1210 (e.g., a double-reinforced, roll-formed column) of the industrial rack and the second replacement column 1101B may additionally support the caudal end of a second column member 1210B of the double column 1210, as generally shown in FIG. 12. Also, as shown in the accompanying figures, the second replacement column 1101B may be shaped as an I-beam. However, the second replacement column 1101B may be shaped in other configurations to provide additional support of the first replacement column 1101A in a single-column repair, or of the rack and the first replacement column 1101A as in a double-column repair.

The first and second replacement columns may also be configured to be disposed adjacent to each other with a face of the second replacement column coupled to a face of the first replacement column. The second replacement column 1101B may also include one or more flanges 1103A, 1103B. The flanges 1103A, 1103B may include one or more hole that align with like holes in a replacement base 1104. The system 1100 may be shaped to receive one or more couplers 102A (as was generally described in FIG. 3) at one or more ends of the first replacement column 1101A. The coupler(s) 102A may join the first replacement column 1101A to the replacement column base 1104 and/or portions of a pallet rack column with a damaged portion removed. In some embodiments, one or both ends of the first replacement column 1101A may be shaped to slide over a coupler 102A, or vice-versa, like a sleeve, and the first replacement column 1101A and coupler 102A may be joined together. Portions of the coupler 102A protruding from the end of the first replacement column 1101A may then engage the replacement column base 1104A and/or portions of a pallet rack existing column with a damaged portion removed. The first replacement column 1101A may include a square tube section that is perforated on all four sides with common pallet rack cutout profiles and connection patterns including teardrop, Interlake new-style teardrop, Unarco T-bolt, Ridg-U-Rak slotted, structural, keystone, Sturdibilt, and side mount load beam/strut connection patterns. In one embodiment, each side of the first replacement column 1101A is perforated with a specific common pallet rack cutout profile. In other embodiments, each side of the first replacement column 1101A is perforated with one or more specific common pallet rack cutout profiles (e.g., two profiles). The side of the first replacement column 1101A that conforms with or to desired pallet rack cutout profiles associated with another portion of the pallet rack may be positioned to face such other portion so that horizontal or angular struts, beams, members, supports or other members of systems 100, 200, 900, 1000 may be coupled to the first replacement column 1101A and to another portions of the pallet rack. For example, if the pallet rack existing column has teardrop profiles, the side of the first replacement column 1101A with teardrop profiles may be positioned to face an existing column to which it will be coupled via struts, beams, members, supports or other aspects of embodiments described herein, e.g., horizontal adjustable strut 110. The second replacement column 1101B may be configured as a reinforcing member to provide additional support for the system 1100 generally, and the first replacement column, in particular. In some embodiments, the reinforcing member 104A includes an I-beam that is joined to the replacement base 1104. The second replacement column 1101B may also include one or more mounting holes 1105 that are shaped to receive an existing or additional horizontal or angular support structure (e.g., struts or beams) between the system 1100 and the existing columns of the rack. For example, one or more fasteners may pass through both a horizontal strut 120 and one or more mounting holes 1105 to affix the horizontal strut 120 to the second replacement column 1101B. The second replacement column 1101B may also include one or more attachment elements or brackets 1205 to affix one or more struts to the respective second replacement column 1101B. For example, a bracket 1205 may be configured to receive an existing strut of the industrial pallet rack, wherein the bracket is further configured to be disposed on a face of the second replacement column.

A column cuff 1106 may couple the first replacement column 1101A to an undamaged portion of a damaged column. The damaged portion may be cut away and an undamaged portion of the existing column may remain. In a single-column repair, the caudal portion of the undamaged portion of the existing column may be coupled to the first replacement column 1101A using cuff 1106. In one embodiment, the caudal end of the undamaged portion of the existing column may rest or sit on and thereby be at least partially supported by a column cap (e.g., column cap 108). In other embodiments, there may exist a space between the caudal end of the undamaged portion of the damaged column and the column cap. The column cuff 1106 may include a front cuff 1106A and a back cuff 1106B that, in a single-column repair, may both be coupled to the first replacement column 1101A and the undamaged portion of a damaged existing column (e.g., a caudal portion). In double-column repairs, the back cuff 106B may be removed or applied to the interior face of the second column. The column cuff 1106 may provide further adjustability for small height differences between manufacturers or field installation conditions such as shimming at the floor and base plate thicknesses. In some embodiments, the cuff 1106 is a connection joint. The cuff 1106 may be formed of steel or other material that is suitable to withstand various load forces of the pallet rack in operation. For example, the cuff 1106 may be made from sheet steel and formed into a “C” shape to cradle both the first replacement column 1101A and the existing cut away rack section or undamaged portion of a damaged existing column. The cuff 1106 may have several horizontal and vertical slots to accommodate a variety of pallet rack hole patterns. The cuff 1106 may include one or more fasteners 1106A (e.g., bolts, nuts, washers, grade 8 hardware, etc.) to help secure the cuff 1106 to the first replacement column 1101A and/or an undamaged portion (e.g., a caudal portion) of damaged existing column. In some embodiments, fasteners 1206A may include at least one unique fastener to make connections that would protrude into a pallet storage area resulting in a “no snag” connection (e.g., a barrel nut). The column cuff 1106 may also include fasteners and/or hardware to affix additional or existing support structures (e.g., struts and beams) on the first replacement column 1101A, the second replacement column 1101B, or between the replacement column and a pallet rack existing column. For example, a horizontal or angular strut between pallet rack existing columns may have been affixed to a damaged portion of an existing column. During the repair process, this horizontal or angular strut may be separated from the damaged portion of the existing column and then re-attached to the system 1100. In some embodiments, a right angle bracket may be used to reattach this existing horizontal or diagonal strut on the system 1100.

Aspects of embodiments described herein may be interchangeable with each other. For example, brackets 210C and 210D may be interchangeable with saddle connections 110C and 110D. Multiple horizontal adjustable struts 110,210 may be used. Horizontal strut 120 may be used in connection with system 200. Cuff 106 may be interchangeable cuff 206 and 1206. And horizontal adjustable struts 110, 210 may be used in lieu of horizontal strut 120 in system 100. Similarly the means for setting adjustment struts 110, 210 may be interchangeable.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

The foregoing description and drawings merely explain and illustrate exemplary aspects of the disclosure and the invention is not limited thereto. While the specification is described in relation to certain implementation or embodiments, many details are set forth for the purpose of illustration. Thus, the foregoing merely illustrates the exemplary principles of the disclosure. For example, the disclosure may have other specific forms without departing from its spirit or essential characteristic. The described arrangements are illustrative and not restrictive. To those skilled in the art, the disclosure is susceptible to additional implementations or embodiments and certain of these details described in this application may be varied considerably without departing from the basic principles of the disclosure. It will thus be appreciated that those skilled in the art will be able to devise various arrangements which, although not explicitly described or shown herein, embody the principles of the disclosure and, thus, within its scope and spirit.

What is claimed is:

1. A system for repairing an upright frame of an industrial pallet rack while the industrial pallet rack is in use and standing on a floor, the system comprising:
a replacement column extending away from a replacement base;
a first strut having a first end configured to be affixed to a face of the replacement column and a second end configured to be affixed to a floor; and
the replacement column being configured to receive a first end of a second strut, such that a second end of the second strut operatively terminates at an existing column of the industrial pallet rack, wherein the replacement column is configured to be disposed opposite to the existing column.

2. The system of claim 1, wherein the second strut is an existing strut associated with the industrial pallet rack.

3. The system of claim 1, further comprising the second strut.

4. The system of claim 1, further comprising a connection saddle configured to be affixed to the second strut and covering a gap in the second strut, wherein the connection saddle includes a saddle aperture configured to be aligned with the gap and further configured to permit the second strut to pass through the saddle aperture and the gap to the floor.

5. The system of claim 1, further comprising a coupler, wherein the replacement column and base are configured to be joined by a coupler.

6. The system of claim 1, wherein the replacement base includes a coupler that extends cephalically, and a caudal portion of the replacement column is configured to receive the coupler.

7. The system of claim 3, wherein the replacement column includes a coupler that extends caudally, and a cephalic portion of the replacement base is configured to receive the coupler.

8. The system of claim 1, wherein the replacement column includes a plurality of faces, each of the faces including a different pallet rack connection cutout pattern.

9. The system of claim 6, wherein each of the plurality of faces is flat.

10. The system of claim 1, wherein the first strut is an adjustable strut that includes a first adjustable strut portion and a second adjustable strut portion configured to permit adjustment of a length of the first strut between the replacement column and the floor.

11. The system of claim 3, wherein the second strut is an adjustable strut that includes a first adjustable strut portion and a second adjustable strut portion configured to permit adjustment of a length of the second strut between the replacement column and the existing column.

12. The system of claim 11, further comprising a connection saddle configured to be affixed to the second strut and covering a gap in the second strut, wherein the connection saddle includes a saddle aperture configured to be aligned with the gap and further configured to permit the second strut to pass through the saddle aperture and the gap to the floor, the connection saddle including one or more lateral bracing members configured to extend caudally toward the floor on one or more sides of the first adjustable strut portion and the second adjustable strut portion.

13. The system of claim 1, further comprising a cuff configured to couple the replacement column to an undamaged portion of a damaged column of the industrial pallet rack.

14. The system of claim 1, wherein the replacement column and replacement base is an integrated one-piece member.

15. The system of claim 1, wherein the replacement base includes a reinforcing member disposed between two components of the replacement base, the reinforcing member configured to provide additional support for the replacement column.

16. The system of claim 15, wherein the reinforcing member includes a gusset.

17. The system of claim 1, wherein the first strut includes one or more footings affixed to a body of the angular adjustable strut by a pivot pin and rotatable about the pivot pin.

18. The system of claim 1, wherein the first strut is configured to be disposed on an angle with respect to the floor.

19. The system of claim 1, wherein the second strut is configured to be disposed substantially parallel to the floor.

20. A system for repairing an upright frame of an industrial pallet rack while the industrial pallet rack is in use and standing on a floor, the system comprising:
a replacement column extending away from a replacement base;
an angular adjustable strut having a first end configured to be affixed to a face of the replacement column and a second end configured to be affixed to a floor;
a horizontal adjustable strut having a first end configured to be affixed to the face of the replacement column below the first end of the angular adjustable strut and a second end configured to be affixed to an existing column of the industrial pallet rack, wherein the replacement column is configured to be disposed opposite to the existing column, and the horizontal adjustable strut is configured to be disposed level with the floor; and
a connection saddle configured to be affixed to the horizontal adjustable strut and covering a gap in the horizontal adjustable strut, wherein the connection saddle includes a saddle aperture configured to be aligned with the gap and further configured to permit the angular adjustable strut to pass through the saddle aperture and the gap to the floor.

21. A system for repairing an upright frame of an industrial pallet rack while the industrial pallet rack is in use and standing on a floor, the system comprising:
a first replacement column extending away from a replacement base; and
a second replacement column configured to be disposed adjacent to the first replacement column and further configured to be coupled to a first face of the first replacement column and coupled to the replacement base.

22. The system of claim 21, further comprising a cuff configured to couple the first replacement column to an undamaged portion of a damaged column.

23. The system of claim 22, wherein:
the damaged column is a double column comprising a first column member coupled to a second column member,
a cephalic portion of the first replacement column is configured to support a caudal portion of the first column member,
a cephalic portion of the second replacement column is configured to support a caudal portion of the second column member, and
the cuff is configured to couple the first column member to the first replacement column.

24. The system of claim 21 further comprising a bracket configured to receive an existing strut of the industrial pallet rack, wherein the bracket is further configured to be disposed on a first face of the second replacement column.

25. The system of claim 21, further comprising a strut having a first end configured to be coupled to a first face of the second replacement column and a second end configured to be coupled to an existing column of the industrial pallet rack.

26. The system of claim 21, wherein:
the caudal end of the second replacement column has a flange configured to be disposed against the replacement base,
a first face of the second replacement column is configured to receive one of a bracket and a strut, and
a second face of the second replacement column is configured to be disposed against the first face of the first replacement column.

27. The system of claim 26 further comprising a plurality of fasteners, wherein:
a first fastener of the plurality of fasteners is configured to couple the caudal end of the second replacement column to the replacement base,
a second fastener of the plurality of fasteners is configured to couple the second face of the second replacement column to the first face of the first replacement column.

28. The system of claim 21, wherein a first face of the second replacement column includes a pallet rack connection cutout pattern.

29. The system of claim 21, further comprising
a first strut having a first end configured to be affixed to a face of one of the first replacement column and the second replacement column, and a second end configured to be affixed to a floor, and
one of the face of the first replacement column and the face of the second replacement column are configured to receive a first end of a second strut, such that a second end of the second strut operative terminates at an existing column of the industrial rack, wherein the first and second replacement columns are configured to be disposed opposite to the existing column.

30. The system of claim 29 further comprising a connection saddle configured to be affixed to the second strut and covering a gap in the second strut, wherein the connection saddle includes a strut opening configured to be aligned with the gap and further configured to permit the first strut to pass through the strut opening to the floor.

31. The system of claim 29, wherein the second strut is an existing strut associated with the industrial pallet rack.

32. The system of claim 29, further comprising the second strut.
